(19) United States
(12) Patent Application Publication
(10) Pub. No.: US 2026/0229773 A1
(43) Pub. Date: Aug. 6, 2026

(54) METHOD AND SYSTEM FOR CALIBRATING AND PROGRAMMING A PHASED ARRAY ANTENNA

(71) Applicant: C-COM SATELLITE SYSTEMS INC., Ottawa (CA)

(72) Inventors: Yuxan Chen, Waterloo (CA); Mohammad Abdollah Chalaki, Waterloo (CA); Slim Boumaiza, Waterloo (CA)

(73) Assignee: C-COM SATELLITE SYSTEMS INC., Ottawa (CA)

(21) Appl. No.: 19/433,467

(22) Filed: Dec. 26, 2025

Related U.S. Application Data
(60) Provisional application No. 63/754,228, filed on Feb. 5, 2025.

(51) Int. Cl. H01Q 3/26; G01S 7/40

(52) U.S. Cl. CPC H01Q 3/267; G01S 7/4008

(57) ABSTRACT

A system and method are provided for calibrating and programming a phased array antenna. The system includes a calibration module configured to generate calibrated constellation control codes corresponding to a desired constellation, a look-up table (LUT) for storing the calibrated constellation control codes, and a processing unit configured to program beamforming integrated circuits (BFICs) to produce an RF radiated signal having the desired constellation. A characterization subsystem is configured to capture a characterization subset of the phased array antenna.

### PRIORITY INFORMATION

This application claims priority from US Provisional Patent Application, Ser. No. 63/754,228, filed on Feb. 5, 2025. The entire content of US Provisional Patent Application, Ser. No. 63/754,228, filed on Feb. 5, 2025, is hereby incorporated by reference.

### BACKGROUND

The contents of the following references are hereby incorporated by reference and are used for facilitating understanding of the background of the present invention:
1. S. Research, “Samsung 6G Vision,” Samsung, Tech. Rep., 2020, https://cdn.codeground.org/nsr/downloads/researchareas/20201201 6G Vision web.pdf.
2. K. Technologies, “3 Key Challenges Implementing and Testing MIMO and Beamforming in 5G Base Stations and Components,” Keysight Technologies, Tech. Rep., 2020, https://www.keysight.com/us/en/assets/7018-06534/white-papers/5992-3752.pdf.
3. Z. Li et al., “A 39-GHz CMOS Bidirectional Doherty Phased-Array Beamformer Using Shared-LUT DPD With Inter-Element Mismatch Compensation Technique for 5G Base Station,” IEEE J. Solid-State Circuits, vol. 58, no. 4, pp. 901-914, 2023.
4. Y. Wang et al., “A 39-GHz 64-Element Phased-Array Transceiver With Built-In Phase and Amplitude Calibrations for Large-Array 5G NR in 65-nm CMOS,” IEEE J. Solid-State Circuits, vol. 55, no. 5, pp. 1249-1269, 2020.
5. D. L. Yan, C. K. Sim, H. A. M. Arif, N. A. B. Kuyob, M. K. Raja, and K. T. C. Chai, “A 35 mW, 2.32 dB NF, 1.1° Phase Error, 1821.2 GHz Beamforming Receiver IC for Satcom the Move (SOTM) Phased Arrays,” IEEE Trans. Circuits Syst. II, vol. 70, no. 10, pp. 3847-3851, 2023.
6. Y. Xiong, Y Pu, Z. Yu, Y Yao, X. Huang, and G. Wang, “A 2-20-GHz 360° VGPS MMIC With Reverse-Slope Phase Compensation,” IEEE Trans. Circuits Syst. I, pp. 1-14, 2023.
7. B. Sadhu et al., “A 24-30-GHz 256-Element Dual-Polarized 5G Phased Array Using Fast On-Chip Beam Calculators and Magnetoelectric Dipole Antennas,” IEEE J. Solid-State Circuits, vol. 57, no. 12, pp. 3599-3616, 2022.
8. Y Yamazaki et al., “A 37-43.5-GHz Phase and Amplitude Detection Circuit With 0.049° and 0.036-dB Accuracy for 5G Phased-Array Calibration Using Transformer-Based Injection-Enhanced ILFD,” IEEE J. Solid-State Circuits, vol. 58, no. 10, pp. 2851-2860, 2023.
9. A. Valdes-Garcia et al., “A Fully Integrated 16-Element Phased-Array Transmitter in SiGe BiCMOS for 60-GHz Communications,” IEEE J. Solid-State Circuits, vol. 45, no. 12, pp. 2757-2773, 2010.
10. E.-T. Sung, S. Wang, and S. Hong, “A 60-GHz Polar Vector Modulator With Lookup Table-Based Calibration,” IEEE Microw. Wireless Compon. Lett., vol. 31, no. 6, pp. 572-574, 2021.
11. C. So, E.-T. Sung, and S. Hong, “A 60-GHz VGPS Based Body Floated RF-DAC Structure,” IEEE Trans. Circuits Syst. II, vol. 69, no. 12, pp. 4749-4753, 2022.
12. N. Wei et al., “A Calibration Scheme for 24-28-GHz Variable-Gain Phase Shifter in 65-nm CMOS,” IEEE Trans. Circuits Syst. II, vol. 69, no. 4, pp. 1996-2000, 2022.
13. S. Wang, J. Park, and S. Hong, “A K-Band Variable-Gain Phase Shifter Based Gilbert-Cell Vector Synthesizer With RC-RL Poly-Phase Filter,” IEEE Microw. Wireless Compon. Lett., vol. 31, no. 4, pp. 393-396, 2021.
14. J. Park, S. Lee, J. Chun, L. Jeon, and S. Hong, “A 28-GHz FourChannel Beamforming Front-End IC With Dual-Vector Variable Gain Phase Shifters for 64-Element Phased Array Antenna Module,” IEEE J. Solid-State Circuits, vol. 58, no. 4, pp. 1142-1159, 2023.
15. D. Zhao et al., “A K-Band Hybrid-Packaged Temperature-Compensated Phased-Array Receiver and Integrated Antenna Array,” IEEE Trans. Microw. Theory Techn., vol. 71, no. 1, pp. 409-423, 2023.
16. T. Takahashi, Y Konishi, S. Makino, H. Ohmine, and H. Nakaguro, “Fast Measurement Technique for Phased Array Calibration,” IEEE Trans. Antennas Propag., vol. 56, no. 7, pp. 1888-1899, 2008.
17. H.-J. Yoon and B.-W. Min, “Improved Rotating-Element Electric-Field Vector Method for Fast Far-Field Phased Array Calibration,” IEEE Trans. Antennas Propag., vol. 69, no. 11, pp. 8021-8026, 2021.
18. M. Liu and Z. Feng, “Combined Rotating-element Electric-field Vector (CREV) Method for nearfield Calibration of Phased Array Antenna,” in International Conf. Microw. Millimeter Wave Technol., 2007, pp. 1-4.
19. A. Ben Ayed, H. Jin, B. Tung, P. Mitran, and S. Boumaiza, “Array Calibration and Digital Predistortion Training Using Embedded NF Feedback Probes and Orthogonal Coding for Enhancing the Performance of Millimeter-Wave Beamforming Arrays,” IEEE Microw. Wireless Technol. Lett., vol. 33, no. 6, pp. 891-894, 2023.
20. S. Silverstein, “Application of orthogonal codes to the calibration of active phased array antennas for communication satellites,” IEEE Trans. Signal Process., vol. 45, no. 1, pp. 206-218, 1997.
21. E. Lier, M. Zemlyansky, D. Purdy, and D. Farina, “Phased array calibration and characterization based orthogonal coding: Theory and experimental validation,” in IEEE Int. Symp. Phased Array Syst. Technol., 2010, pp. 271-278.
22. Z. Wang, F. Zhang, H. Gao, O. Franek, G. F. Pedersen, and W. Fan, “Over-the-Air Array Calibration of mmWave Phased Array in BeamSteering Mode Based Measured Complex Signals,” IEEE Trans. Antennas Propag., vol. 69, no. 11, pp. 7876-7888, 2021.
23. R. Long, J. Ouyang, F. Yang, W. Han, and L. Zhou, “Multi-Element Phased Array Calibration Method by Solving Linear Equations,” IEEE Trans. Antennas Propag., vol. 65, no. 6, pp. 2931-2939, 2017.
24. S. Tang, Z. Wang, C. Pan, R. Su, W. Fan, and S. Gao, “A Fast and Efficient Calibration Method for Phased Array Antennas Using FourierStructured Excitation Matrix,” IEEE Trans. Antennas Propag., vol. 71, no. 3, pp. 2290-2299, 2023.
25. H. Aumann, A. Fenn, and F. Willwerth, “Phased array antenna calibration and pattern prediction using mutual coupling measurements,” IEEE Trans. Antennas Propag., vol. 37, no. 7, pp. 844-850, 1989.
26. A. Nafe, K. Kibaroglu, M. Sayginer, and G. M. Rebeiz, “An In-Situ SelfTest and Self-Calibration Technique Utilizing Antenna Mutual Coupling for 5G Multi-Beam TRX Phased Arrays,” in IEEE MTT-S Int. Microw. Symp., 2019, pp. 1229-1232.
27. A. Nafe, A. H. Aljuhani, K. Kibaroglu, M. Sayginer, and G. M. Rebeiz, “In-Situ Self-Test and Self-Calibration of Dual-Polarized 5G TRX Phased Arrays Leveraging Orthogonal-Polarization Antenna Couplings,” in IEEE MTT-S Int. Microw. Symp., 2020, pp. 1081-1084.
28. Y. Aslan, P. Aubry, N. B. Onat, J. Janssen, M. Geurts, and A. Yarovoy, “Heuristic Over-the-Air Calibration of Beamformer ICs in Active mmWave Phased Arrays,” in IEEE Conf. Antenna Meas. Appl., 2023, pp. 840-845.
29. R. X. F. Bude, K. A. P. Van Hastenberg, U. Johannsen, and A. B. Smolders, “Near-Field Calibration Methods for Integrated Analog Beamforming Arrays and Focal Plane Array Feeds,” IEEE Open J. Antennas Propag., vol. 4, pp. 860-870, 2023.
30. M. H. Sahlabadi, H. Yu, J. Xia, and S. Boumaiza, “A DigitallyControlled Bidirectional 24-32 GHz VGPS in 45 nm SOI CMOS,” IEEE Trans. Circuits Syst. II, pp. 1-1, 2024.
31. Xia, W. Chen, F. M. Ghannouchi, and Z. Feng, “An 18-50-GHz—Modulated Quasi-Continuous Digital Vector-Modulation Phase Shifter With Variable Gain Control,” IEEE Microw. Wireless Compon. Lett., vol. 32, no. 1, pp. 60-63, 2022.
32. Y. Chen and S. Boumaiza, “Rapid Calibration of Variable Gain Phase Shifters: A Novel Characterization Approach with Sparse Measurements,” in IEEE MTT-S Int. Microw. Symp., 2024, pp. 710-713.
33. H. Jin, A. Ben Ayed, Z. He, B. Tung, and S. Boumaiza, “Embedded NF Probing Antenna for Enhancing the Performance of 37-41 GHz Linear and Dual-Polarized Phased Antenna Arrays,” IEEE Microw. Wireless Technol. Lett., vol. 33, no. 6, pp. 911-914, 2023.

As global internet usage and demand continue to surge, extensive research is being conducted to enhance the quality, capacity and coverage of communication systems. Fifth generation (5G) and beyond communication systems are supporting this trend by expanding into the millimeter wave (mmWave) frequency bands, enabling ultra-low latency and data rates of up to 20 Gbps [1]. However, mmWave signal transmission faces significant challenges, including high path loss due to increased atmospheric absorption at higher frequencies. To address this, large-scale multiple antenna systems employ advanced radio architectures, such as analog beamforming systems [1], [2].

A phased array antenna is a collection of antennas arranged in a geometric pattern, to send and receive signals in a desired direction without physically moving the array. These arrays are widely used in applications such as radar systems, satellite communications, and wireless networks. The array may consist of a plurality of antenna elements, arranged in a two-dimensional grid. For example, a 4×4 array has 16 elements, a 10×10 array has 100 elements. Each antenna element can transmit or receive signals, typically operating at the same frequency and regulated by a beamforming integrated circuit (BFIC) for adjusting the radiated signal amplitude and phase. By adjusting these amplitudes and phases, the array can control the shape of the radiation pattern and the direction of the beams. A processing unit generates control signals for regulating the BFICs to form a desired radio frequency (RF) radiated pattern. The RF radiated signal is commonly visually represented using a constellation diagram comprising a collection of points, referred to as constellation points or symbols. Each constellation point represents a specific combination of amplitude and phase used by the transmit BFICs to encode a corresponding group of binary digits.

The phased array antenna dynamically shapes the radiation patterns to increase the equivalent isotropic radiated power (EIRP) and signal-to-noise ratio (SNR) in an intended transmission direction [2]. This is accomplished using various beamforming systems that utilize beamforming integrated circuits (BFICs) with variable-gain phase shifters (VGPS) on each radio frequency (RF) chain, allowing for precise adjustments of signal amplitude and phase [3]-[15].

In phased array antennas, hardware non-idealities such as circuit response variations, process variation, impedance mismatches, component aging and antenna coupling effect, introduce phase and gain errors that degrade beamforming performance. These errors can result in reduced gain, increased side lobe levels, shallower nulls, and beam-pointing inaccuracies [8]. Consequently, calibration is essential to compensate for phase and gain errors within phased array antennas. Various calibration methods have been reported in the literature, including the rotating-element electric field vector (REV) [16]-[18], orthogonal coding [19]-[21], complex excitation [22]-[24], and mutual coupling [25]-[27] based methods. As illustrated in FIG. 1, the entire RF chain of each BFIC element and phased array antenna is treated as a single block with aggregated gain and phase errors. Additionally, gain and phase errors in BFICs and phased arrays are generally assumed to be either constant or variable across the entire constellation.

When phase and gain errors are assumed to be constant, calibration methods typically involve characterizing each element in the BFIC or phased array antenna to determine the necessary corrections [16]-[18], [20]-[24]. In these cases, the number of measurements required for calibration matches the number of elements and remains independent of the number of constellation states per element. While this is advantageous, the assumption of constant errors does not always hold in practical BFICs and phased array antennas. As illustrated in FIG. 2, these variations reduce the effectiveness of such calibration methods [28], [29].

In contrast, calibration methods that account for varying gain and phase errors across the constellation require characterizing each RF chain in each element of the BFIC or phased array antenna across all possible control states. The states with measurements closest to the desired constellation points are then selected to achieve optimal calibration accuracy [10], [13], [30], [31]. This approach, known as exhaustive search, does not assume prior knowledge of the BFIC or phased array response.

However, the large number of measurements required and the resulting extended measurement time present significant challenges, particularly for large arrays and high resolution BFICs.

Various methods exist to reduce the number of required measurements while accounting for varying errors. For example, the pseudo-exhaustive search method in [29] assumes local homogeneity within the constellation, allowing interpolating the full constellation from a uniformly selected subset. However, the resulting accuracy is sensitive to the effectiveness of clustering the entire constellation into sub-areas with homogeneous behavior. Alternatively, the control sampling method in [28] simplifies the varying error model by assuming that gain and phase control errors are decoupled.

Characterization is first performed separately on a subset of constant-gain and constant-phase series, and then interpolation is used to determine the gain and phase control codes for a targeted constellation point. Nonetheless, this method has limited calibration accuracy due to the inherent coupling between gain and phase errors in practice.

### SUMMARY

It is an object of the invention to provide a system and method for calibrating and programming a phased array antenna that obviates or mitigates at least one disadvantage of existing systems. The method comprises the steps of capturing a characterization subset, a calibration module configured for producing a constellation model and generating calibrated constellation control codes, a look-up table (LUT) for storing the calibrated constellation control codes corresponding to a desired constellation, and a processing unit for programming the BFICs for producing an RF radiated signal having the desired constellation (FIG. 22, a first embodiment of the present invention).

In accordance with the present invention there is provided a system for a phased array antenna including a beamforming subsystem having a plurality of BFICs and antenna elements, a characterization subsystem configured to capture a characterization subset of the phased array antenna, a calibration module configured for producing a constellation model and generating calibrated constellation control codes, a look-up table (LUT) for storing the calibrated constellation control codes, and a processing unit configured to program beamforming integrated circuits (BFICs) to produce an RF radiated signal having the desired constellation. The look-up table is maintained in a memory, which may include a non-volatile memory or other memory storage devices (FIG. 22, a first embodiment of the present invention).

The processing unit and calibration module include processing circuitry and may further include a storage device, such as a random-access memory (RAM), read-only memory (ROM), electrically programmable ROM (EPROM), solid-state drive (SSD), and the like. Where a method comprising a series of process steps is implemented by the processing unit processing unit and calibration module, those process steps may be stored in the storage device as a series of instructions. The processing unit and calibration module may also comprise a field programmable gate array (FPGA). In addition, those of ordinary skill in the art will recognize that devices such as FPGAs, application specific integrated circuits (ASICs), digital signal processors (DSP) or the like, may also be used without departing from the scope and spirit of the inventive concepts disclosed herein.

In accordance with a further aspect of the present invention there is provided a system for a phased array antenna including a beamforming subsystem having a plurality of BFICs and antenna elements, a calibration module configured for receiving measured constellation data, producing a constellation model and generating calibrated constellation control codes, a look-up table (LUT) for storing the calibrated constellation control codes, and a processing unit configured to program beamforming integrated circuits (BFICs) to produce an RF radiated signal having the desired constellation. The look-up table is maintained in a memory, which may include a non-volatile memory or other memory storage devices (FIG. 23, a second embodiment of the present invention).

In accordance with a further aspect of the present invention there is provided a system for a phased array antenna including a beamforming subsystem having a plurality of BFICs and antenna elements, a look-up table (LUT) for storing calibrated constellation control codes, and a processing unit configured to program beamforming integrated circuits (BFICs) to produce an RF radiated signal having the desired constellation. The look-up table is stored in a memory subsystem, which may include a non-volatile memory or other memory storage devices (FIG. 24, a third preferred embodiment of the present invention).

### BRIEF DESCRIPTION OF THE DRAWINGS

The drawings are only for purposes of illustrating various embodiments and are not to be construed as limiting, wherein:

FIG. 1 illustrates a RF chain block model;

FIG. 2 illustrates a constellation of a BFIC with 8-bit phase and 8-bit gain states and its calibrated constellation targeting 6-bit phase and 12 gain states with 1 dB tuning resolution;

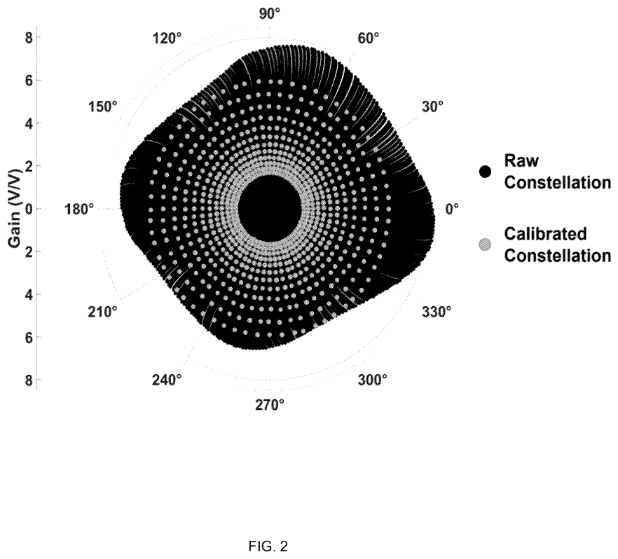

FIG. 3 illustrates a characterization subset with outline data sampling size of 23 and gain data sampling size of 8;

FIG. 4 illustrates a flow diagram of the disclosed modeling method;

FIG. 5 illustrates a gain profile scaling profile adjustment using an observation at the auxiliary gain index of 147;

FIG. 6 illustrates a phase profile shifting profile adjustment using an observation at the auxiliary phase index of 71.

FIG. 7 illustrates a flow diagram of the optimized modeling method with the optimized characterization subset;

FIG. 8 illustrates a flow diagram of the disclosed calibration routines: (a) open-loop calibration; (b) closed-loop calibration;

FIG. 9 illustrates an adaptive Kernel Search flow charts: (a) Validation criteria; (b) Position compensation and kernel size expansion;

FIG. 10 illustrates a kernel demonstration for size: (a) N=1; (b) N=3;

FIG. 11 illustrates a validation criteria: (a) Distance criterion; (b) Encirclement criterion;

FIG. 12 illustrates a validation region for a targeting point;

FIG. 13 illustrates a position compensation for a kernel of size 3;

FIG. 14 illustrates a gain states for a 4×4 phased array using Taylor window gain tapering: (a) Forced tapering; (b) Taper-aware;

FIG. 15 illustrates a measurement setup for BFIC #1: (a) Setup block diagram; (b) Evaluation board;

FIG. 16 illustrates a constellations for BFIC #1: (a) Exhaustive search; (b) No calibration; (c) Disclosed closed-loop routine; (d) Disclosed open-loop routine;

FIG. 17 illustrates a measurement setup for BFIC #2: (a) Setup block diagram; (b) Evaluation board;

FIG. 18 illustrates a constellations for BFIC #2: (a) Exhaustive search; (b) No calibration; (c) Disclosed closed-loop routine; (d) Disclosed open-loop routine;

FIG. 19 illustrates a measurement setup for 4×4 phased array antennas (a) Array under test; (b) Far-field setup;

FIG. 20 illustrates a measured radiation pattern of the BFIC #1 phased array: (a) No-taper; (b) Taper awareness; (c) Gain taper comparison; (d) Steered beam;

FIG. 21 illustrates a measured radiation pattern of the BFIC #2 phased array: (a) No-taper; (b) Taper awareness; (c) Gain taper comparison; (d) Steered beam;

FIG. 22 illustrates a first embodiment of the present invention;

FIG. 23 illustrates a second embodiment of the present invention;

FIG. 24 illustrates a third preferred embodiment of the present invention;

FIG. 25 illustrates results for an 8-bit gain and 8-bit phase BFIC;

FIG. 26 illustrates BFIC #1 calibration results comparison targeting different constellation settings;

FIG. 27 illustrates BFIC #2 calibration results comparison targeting different constellation settings;

FIG. 28 illustrates BFIC #1 phased antenna array calibration results; and

FIG. 29 illustrates BFIC #2 phased antenna array calibration results.

### DETAILED DESCRIPTION

The present invention is now described in detail with reference to the following exemplary embodiments. It should be understood that these embodiments are presented for illustrative purposes only and are not intended to limit the scope or spirit of the invention, which is defined solely by the appended claims.

In a preferred embodiment, a beamforming subsystem includes a plurality of beamforming integrated circuits (BFICs) to precisely programming the phase and amplitude direction thereby changing the shape and direction of an RF radiated signal. In this disclosure, a constellation is defined as a visual representation of an RF radiated signal. Each point on the constellation diagram, known as a constellation point or symbol, represents a specific, unique combination of amplitude and phase that the BFICs uses to encode a group of binary digits.

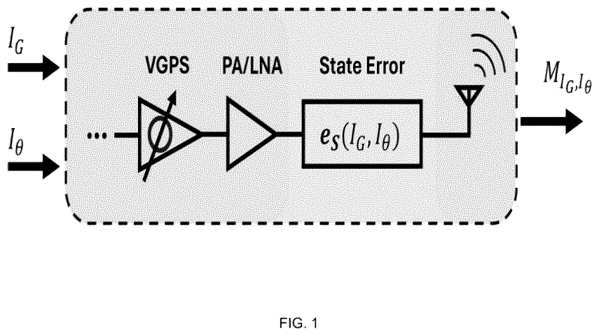

The present invention provides a rapid calibration system capable of accurately and efficiently modelling the constellation of a BFIC and RF chain as illustrated in FIG. 1. The system and method achieve results comparable to those of the exhaustive search method but with significantly fewer measurements, for example three orders of magnitude times fewer measurements. Building upon the groundwork in [32], formulations are disclosed to model the constellation with high accuracy, where the model construction is achieved by conducting measurements for an optimized subset of the constellation. Employing the model, an open-loop calibration routine (also referred to as an unsupervised calibration routine) or a closed-loop calibration routine (also referred to as a supervised calibration routine) generates the calibrated constellation control codes corresponding to a desired constellation and stored in a look up table (LUT). The closed-loop calibration routine allows for a tailored calibration approach offering definable accuracy alongside adjustable constellation resolution. The open-loop routine prioritizes calibration speed by maintaining the number of required measurements at a constant minimum.

The present invention discloses a method for calibrating and programming a phased array antenna comprising the steps of capturing a constellation characterization subset of an RF radiated signal, configuring a calibration module for producing a constellation model and generating calibrated constellation control codes and configuring a processing unit for programming the BFICs for transmitting an RF radiated signal having the desired constellation. In an embodiment, a characterization subsystem is configured to capture the characterization subset of the RF radiated signal.

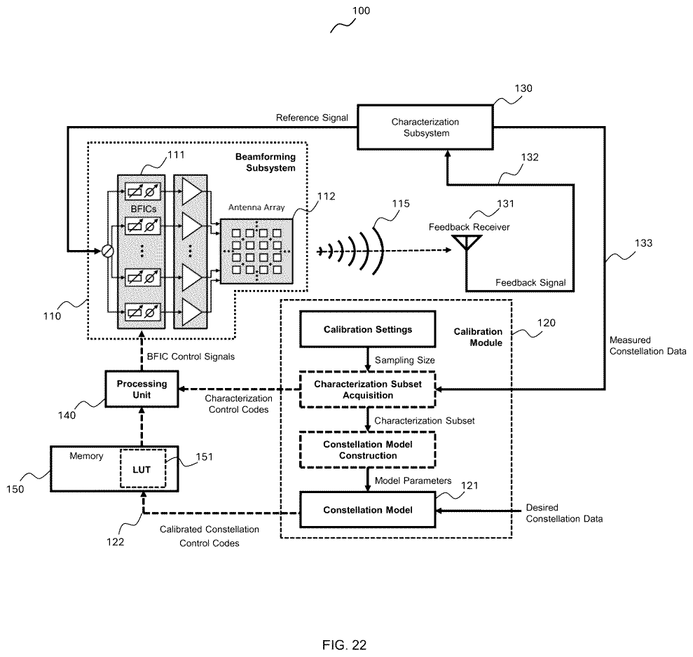

FIG. 22 illustrates a first embodiment of the present invention for implementing the calibration and programming a phased array antenna. System 100 comprises a beamforming subsystem 110, a characterization subsystem 130, a calibration module 120, a memory 150, and a processing unit 140. The beamforming subsystem 110 comprises a plurality of BFICs 111 and a phased array antenna 112 and is configured to produce an RF radiated signal 115. A feedback receiver 131 is configured to receive the RF radiated signal 115 and produce a feedback signal 132. The characterization subsystem 130 is configured to receive and process the feedback signal 132 and provide measured constellation data 133 to a calibration module 120 which performs operations including characterization subset acquisition and constellation model construction. The characterization subset acquisition generates a characterization subset, and the constellation model construction generates model parameters for a constellation model 121. The constellation model 121 is configured to receive desired constellation data and to generate calibrated constellation control codes 122 corresponding thereto. The calibrated control codes 122 are stored in a look-up table (LUT) 151 maintained in memory 150, which may comprise non-volatile memory or other suitable memory storage devices. Processing unit 140 is configured to retrieve the calibrated constellation control codes 122 from the look-up table (LUT) 151 and produce control signals for programming the plurality of BFICs 111. In certain embodiments, the calibration module 120 is integrated with the processing unit 140 or provided as a separate processing unit.

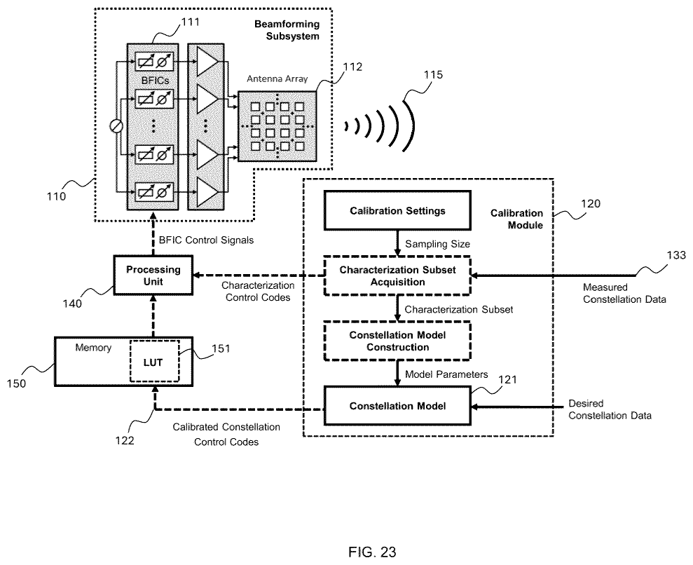

FIG. 23 illustrates a second embodiment of the present invention for implementing the calibration and programming a phased array antenna of the present invention. System 200 comprises a beamforming subsystem 110, a calibration module 120, a memory 150, and a processing unit 140. The beamforming subsystem 110 comprises a plurality of BFICs 111 and a phased array antenna 112 and is configured to produce an RF radiated signal 115. A calibration module 120 is configured to receive measured constellation data 133 and performs operations including characterization subset acquisition and constellation model construction. The characterization subset acquisition generates a characterization subset, and the constellation model construction generates model parameters for a constellation model 121. The constellation model 121 is configured to receive desired constellation data and to generate calibrated constellation control codes 122 corresponding thereto. The calibrated control codes 122 are stored in a look-up table (LUT) 151 maintained in memory 150, which may comprise non-volatile memory or other suitable memory storage devices. Processing unit 140 is configured to retrieve the calibrated constellation control codes 122 from the look-up table (LUT) 151 and produce control signals for programming the plurality of BFICs 111. In certain embodiments, the calibration module 120 is integrated with the processing unit 140 or provided as a separate processing unit.

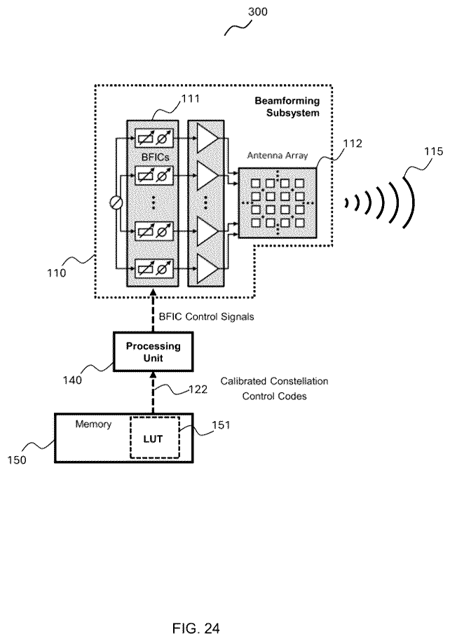

FIG. 24 illustrates a third embodiment of the present invention for implementing the calibration and programming a phased array antenna of the present invention. System 300 comprises a beamforming subsystem 110, a memory 150, and a processing unit 140. The beamforming subsystem 110 comprises a plurality of BFICs 111 and a phased array antenna 112 and is configured to produce an RF radiated signal 115. Calibrated constellation control codes 122 are stored in a look-up table (LUT) 151 maintained in memory 150, which may comprise non-volatile memory or other suitable memory storage devices. Processing unit 140 is configured to retrieve the calibrated constellation control codes 122 from the look-up table (LUT) 151 and produce control signals for programming the plurality of BFICs 111. In this embodiment, the calibration module, as previously described, is provided as a separate processing unit.

In an embodiment, a representative implementation of the system is evaluated through calibration of two commercially available BFICs and two 4×4 phased array antennas, demonstrating operation consistent with the disclosed functionality. For high-resolution BFIC calibration, the disclosed method achieves phase and gain root mean square errors (RMSE) of 0.45 degrees and 0.03 dB, closely matching the 0.4 degrees and 0.02 dB obtained by the exhaustive search method—with 1100 times fewer measurements. The measured radiation patterns produce virtually identical patterns to those obtained via the exhaustive search method. The modeling method is described in detail in Section I below. Section II presents examples of open-loop and closed-loop calibration routines. Evaluated results are provided in Section III.

Section I. Constellation Modelling: The constellation of an ideal BFIC or an RF chain forms a series of uniform distributed concentric circles. However, nonidealities, such as uneven control steps and coupling between control variables, distort the constellation.

Let the constellation be represented by the constellation is represented by a complex-valued bivariate function, ƒ(x,y), with a range that ideally describes concentric circles in polar coordinates. Assuming that ƒ(x,y) is differentiable and that the coupling between the two control variables is weak, the function can be approximated by,

$$f ( x , y ) \approx h ( x ) g ( y ) \qquad ( 1 )$$

where h(x) and g(y) serve as basis functions, capturing the contributions of each variable independently. To determine these basis functions, sampling of ƒ(x,y) is performed over a grid centered at (x₀, y₀). This involves taking measurements along the x-axis with y fixed at y₀, and along the y-axis with x fixed at x₀. This results in a local model of ƒ(x,y):

$$f ( x , y ) \approx f ( x , {y}_{0} ) \frac{f ( {x}_{0} , y )}{f ( {x}_{0} , {y}_{0} )} , for ( x , y ) \approx ( {x}_{0} , {y}_{0} ) \qquad ( 2 )$$

The accuracy depends on how well the sampled grid represents the entire constellation. Errors arise when the local model changes for different selections of (x₀, y₀). Assuming similarity between local models across different regions of the constellation, a correction factor k₀(x,y) is introduced to account for variations in the local models. By incorporating the correction factor, the accuracy is extended across the entire domain of ƒ(x,y):

$$f ( x , y ) \approx f ( x , {y}_{0} ) \frac{f ( {x}_{0} , y )}{f ( {x}_{0} , {y}_{0} )} {k}_{0} ( x , y ) \qquad ( 3 )$$

To determine the correction factor k₀(x,y), additional sampling beyond the initial grid centered at (x₀, y₀) is required. Consider an auxiliary set of samples taken at a secondary grid centered at (xₙ, yₙ). The values of k₀(x,y) along this grid are calculated using (3) as follows:

$${k}_{0} ( x , {y}_{n} ) = \frac{f ( x , {y}_{n} )}{f ( x , {y}_{0} )} \frac{f ( {x}_{0} , {y}_{0} )}{f ( {x}_{0} , {y}_{n} )} \qquad ( 4 )$$

$${k}_{0} ( {x}_{n} , y ) = \frac{f ( {x}_{n} , y )}{f ( {x}_{0} , y )} \frac{f ( {x}_{0} , {y}_{0} )}{f ( {x}_{n} , {y}_{0} )} \qquad ( 5 )$$

Additionally, evaluating k₀(x,y) along the initial grid centered at (x₀, y₀) provides the following boundary conditions:

$${k}_{0} ( x , {y}_{0} ) = 1 \qquad ( 6 )$$

$${k}_{0} ( {x}_{0} , y ) = 1 \qquad ( 7 )$$

Due to the constraints imposed by these boundary conditions, k₀(x,y) cannot be approximated in the manner suggested by the decomposition in (1). Therefore, an empirical approach is used to derive an appropriate form of k₀(x,y). In the present invention, k₀(x,y) is constructed by transforming the sampled functions from (4) and (5) across the entire x-y domain, while rigorously enforcing the boundary conditions.

The selection of (x₀, y₀) and (xₙ, yₙ) is assumed to enable the functions in (4) and (5) to display representative patterns. Consequently, an optimization process is applied to enhance the sampling framework by determining optimal values for (x₀, y₀) and (xₙ, yₙ). This approach ensures that the resulting function k₀(x,y) consistently achieves accurate model performance over the entire domain.

In the constellation modeling methods of the present invention, the two grid sampling approach leads to the identification of a specific portion of the constellation for sampling, referred to as the “Characterization Subset.” This subset is optimized to capture the key characteristics required to construct the model in (3) with maximal accuracy and minimal measurements.

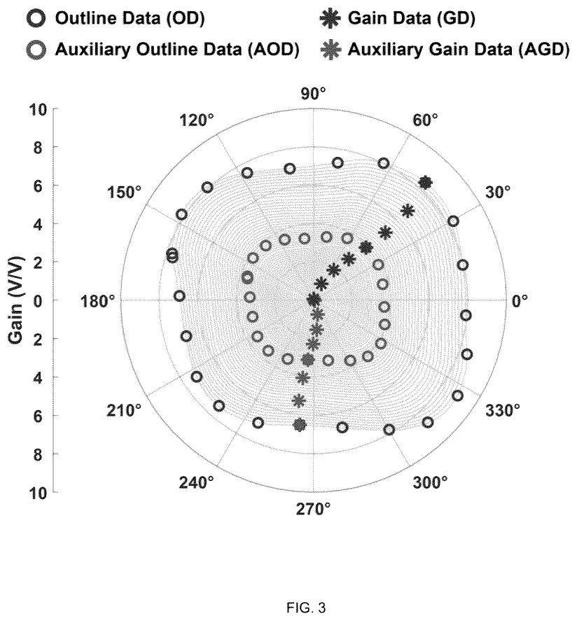

As depicted in FIG. 3, the characterization subset is derived by sampling along two grids of control indices for both gain and phase. The characterization subset comprises four distinct data streams: outline data (OD) and gain data (GD), which are used to construct the local model, and auxiliary outline data (AOD) and auxiliary gain data (AGD), which are used to generate the correction factor. Details regarding the characterization subset can be found in Section I-A, while the optimization process for selecting the most representative sampling indices is discussed in Section I-D.

In the context of a BFIC or an RF chain, the control indices correspond to gain and phase independently. Let I_{G} and I_{θ} denote the control indices for gain and phase, respectively. The complex-valued model in (3) can be decomposed into two real-valued models: ƒ_{G}, representing the gain response, and ƒ_{θ}, representing the phase response. These models are expressed as:

$${f}_{G} ( {I}_{G} , {I}_{θ} ) = \vert f ( {I}_{G} , {I}_{{θ}_{0}} ) \vert \frac{\vert f ( {I}_{{G}_{0}} , {I}_{θ} ) \vert}{\vert f ( {I}_{{G}_{0}} , {I}_{{θ}_{0}} ) \vert} \vert {k}_{0} ( {I}_{G} , {I}_{θ} ) \vert \qquad ( 8 )$$

$${f}_{θ} ( {I}_{G} , {I}_{θ} ) = ∠ f ( {I}_{G} , {I}_{{θ}_{0}} ) + ∠ f ( {I}_{{G}_{0}} , {I}_{θ} ) - ∠ f ( {I}_{{G}_{0}} , {I}_{{θ}_{0}} ) + ∠ {k}_{0} ( {I}_{G} , {I}_{θ} ) \qquad ( 9 )$$

Here, I_{G0} and I_{θ0} represent fixed values of the gain and phase indices that define the initial grid.

To realize the constellation model, the terms of the gain and phase response models in (8) and (9) are acquired by performing measurements for the characterization subset. In the present invention “Mapping Functions”, are applied to extract the gain and phase response characteristics from the measured subset to construct the constellation model as they are in (8) and (9). These mapping functions, as outlined in Section I-B, are classified into the following categories:
1. Main Mapping Functions: Gain Profile (GP), Phase Profile (PP), Gain Envelope (GE), Gain-to-Phase Variation (G2Δθ).
2. Auxiliary Mapping Functions: Auxiliary Gain Profile (AGP), Auxiliary Phase Profile (APP), Auxiliary Gain Envelope (AGE), Auxiliary Gain-to-Phase Variation (AG2Δθ).
3. Composite Mapping Functions: Gain Envelope Scaling Profile (GESP), Gain Profile Scaling Profile (GPSP), Phase Profile Shifting Profile (PPSP).

By analyzing these mapping functions, the expressions for the correction factors are determined, which allows for the construction of the constellation model in Section I-C.

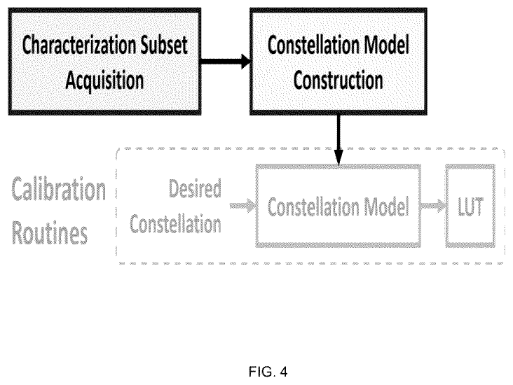

The overall modeling process is illustrated in FIG. 4. Subsequently, in Section II, this constellation model is applied within the calibration routine, where a Look-Up Table (LUT)corresponding to the desired constellation is generated.

Section I-A. Characterization Subset Acquisition: The Characterization Subset aims to capture the characteristics of the constellation, facilitating the construction of the disclosed constellation model. The selection of this subset is optimized to achieve a balance between the number of measurements and model accuracy. The characterization subset consists of two series of measured data along the phase circles (main and auxiliary outline data) and gain circles (main and auxiliary gain data).

The Characterization Subset comprises measurements from two grids of control indices: one centered at (I_{Gmain},I_{θmain}), corresponding to (x₀, y₀) in (3), and another at (I_{Gaux},I_{θaux}), corresponding to (xₙ, yₙ) in (4) and (5). Here, I_{Gmain} and I_{θaux} denote the main and auxiliary gain indices, respectively, while I_{θmain} and I_{θaux} denote the main and auxiliary phase indices.

The corresponding gain and phase control indices are selected from equally spaced sets with predefined sizes, defined as:

$${S}_{G} = \{ {I}_{{G}_{min}} , … , {I}_{{G}_{max}} \} \qquad ( 10 )$$

$${S}_{θ} = \{ {I}_{{θ}_{min}} , … , {I}_{{θ}_{max}} \} \qquad ( 11 )$$

where IGₘᵢₙ and IGₘₐₓ, as well as Iθₘᵢₙ and Iθₘₐₓ, denote the minimum and maximum values of the gain and phase control index ranges for the BFIC or RF chain. The number of elements in each set are referred to as the gain data sampling size for S_{G} and the outline data sampling size for S_{θ}.

The number of elements in each set is pre-selected and referred to as the gain data sampling size for S_{G} and the outline data sampling size for Sθ. The indices I_{Gmain}, I_{Gaux}, I_{θmain}, and I_{θaux} can be any elements within S_{G} and S_{θ} once the sets are defined based on the selected sampling sizes.

Let M_{IG,Iθ} represent the measured complex transmission coefficient when the BFIC or RF chain is controlled using I_{G} and I_{θ} as the gain and phase control indices, respectively. Based on how the control indices are swept, the characterization subset is categorized into two types of data streams:
1. Outline Data: The main and auxiliary outline data, illustrated in FIG. 3, are acquired from:

$$OD ( {I}_{θ} ) = f ( {I}_{{G}_{main}} , {I}_{θ} ) = {M}_{{I}_{{G}_{main}}} , \text{?} , {I}_{θ} ∈ {S}_{θ} \qquad ( 12 )$$

$$AOD ( {I}_{θ} ) = f ( {I}_{{G}_{aux}} , {I}_{θ} ) = \text{?} , {I}_{θ} ∈ {S}_{θ} \qquad ( 13 )$$

$$\text{?} \text{indicates text missing or illegible when filed}$$

2. Gain Data: The main and auxiliary gain data, illustrated in FIG. 3, are acquired from:

$$GD ( {I}_{G} ) = f ( {I}_{G} , {I}_{{θ}_{main}} ) = {M}_{{I}_{G}} , {I}_{{θ}_{main}} , {I}_{G} ∈ {S}_{G} \qquad ( 14 )$$

$$AGD ( {I}_{G} ) = f ( {I}_{G} , {I}_{{θ}_{aux}} ) = {M}_{{I}_{G}} , {I}_{{θ}_{aux}} , {I}_{G} ∈ {S}_{G} \qquad ( 15 )$$

The Characterization Subset can be defined using any fixed gain and phase indices: I_{Gmain}, I_{Gaux}, I_{θmain}, and I_{θaux}. However, the optimal selection of these indices maximizes the captured information and consequently enhances the accuracy of the correction factor. To ensure precise characterization near peak gain and eliminate the need for extrapolation of gain characteristics, I_{Gmain} is selected as the BFICs maximum gain index, I_{Gmax}. The optimal selection of the remaining fixed indices is discussed in Section I-D, where the disclosed modeling method is already detailed.

Different choices of gain data sampling size and outline data sampling size impact modeling performance; insufficient sampling can leave constellation features unresolved, while excessive sampling leads to redundant information and increased measurement time. The optimal sampling sizes suffices to resolve all major features in the constellation. The optimal number increases with greater variations in the constellation and is typically larger for higher-resolution and wider-range BFIC implementations.

To evaluate the optimum sampling size, a figure-of-merit (FOM) as defined as:

$$FOM = {( {EVM}^{2} \cdot measurement count )}^{- 1} \qquad ( 11 a )$$

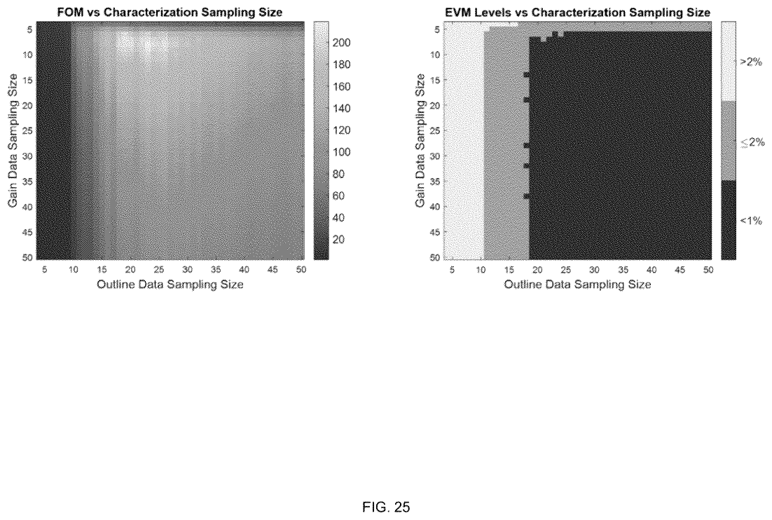

so that the sampling sizes yielding the highest accuracy (lowest EVM—Error Vector Magnitude) for the lowest number of measurements excels. Note that there is a higher emphasis on the accuracy hence the square on EVM. For an 8-bit gain and 8-bit phase BFIC, the FOMs are evaluated by sweeping across different sampling sizes, with the results shown in FIG. 25.

Sampling sizes are selected based on specific system requirements. In the present invention an outline data sampling size of 23 and a gain data sampling size of 8 are chosen to achieve the highest FOM. Notably, the broad area of high FOM provides flexibility in selecting sampling sizes. The EVM plot on the right also illustrates that the performance is stable and the EVM decreases monotonically with the increasing sampling sizes.

Further, the system method of the present invention is applicable for BFICs with different resolutions and the optimum sampling size does not scale linearly with the BFIC resolution, requiring a smaller percentage of constellation points for characterization for higher-resolution BFICs—therefore providing improved calibration efficiency.

Section I-B. Mapping Functions Definition: The constellation is represented by the gain and phase response models in (8) and (9) and is constructed using mapping functions defined in this section. These functions extract the gain and phase response characteristics from the characterization subset to determine each term in the model. 1) Gain Profile: The gain profile quantifies the relationship between the gain index and measured gain. This relation though, varies with phase. The auxiliary gain profile captures gain profile variation across another phase index. The main and auxiliary gain profiles can be defined as:

$$GP ( {I}_{G} ) = \vert GD ( {I}_{G} ) \vert \qquad ( 16 )$$

$$AGP ( {I}_{G} ) = \vert AGD ( {I}_{G} ) \vert \qquad ( 17 )$$

2) Phase Profile: For phase, with the same purpose as above, the main and auxiliary phase profiles are definable as:

$$PP ( {I}_{θ} ) = ∠ OD ( {I}_{θ} ) \qquad ( 18 )$$

$$APP ( {I}_{θ} ) = ∠ AOD ( {I}_{θ} ) \qquad ( 19 )$$

(3) Gain Envelope: To quantify the relationship between the phase index and the measured gain, gain envelopes are defined. The main gain envelope captures how the maximum gain varies across different phase indices, while the auxiliary gain envelope addresses these variations for another gain index, accounting for the influence of gain on shape changes.

$$GE ( {I}_{θ} ) = \vert OD ( {I}_{θ} ) \vert \qquad ( 20 )$$

$$AGE ( {I}_{θ} ) = \vert AOD ( {I}_{θ} ) \vert \qquad ( 21 )$$

(4) Gain-to-Phase Variation: Like the gain envelope, the gain-to-phase variation extracts the relation between the measured relative phase and gain index for two distinct phase indices. The main and auxiliary gain-to-phase variations are:

$$G 2 Δ θ ( {I}_{G} ) = ∠ GD ( {I}_{G} ) - ∠ GD ( {I}_{{G}_{main}} ) \qquad ( 22 )$$

$$AG 2 Δ θ ( {I}_{G} ) = ∠ AGD ( {I}_{G} ) - ∠ AGD ( {I}_{{G}_{main}} ) \qquad ( 23 )$$

(5) Gain Envelope Scaling Profile: Using the predefined main and auxiliary gain envelopes, a new function, named gain envelope scaling profile, can be defined to indicate the relative gain expansion or compression at different phase indices:

$$GESP ( {I}_{θ} ) = \frac{AGE ( {I}_{θ} )}{GE ( {I}_{θ} )} \qquad ( 24 )$$

The gain data at phase indices near the peak of the GESP show the maximum gain compression compared to the mean, while those near the bottom exhibit the highest relative gain expansion. This information is used to determine the optimum choices for I_{θmain} and I_{θaux}.

(6) Gain Profile Scaling Profile: In addition to the gain variations, the shape of the gain profile is influenced by the phase index. To quantify how the normalized shape of the gain profile changes across different phase indices, the gain profile scaling profile is defined as:

$$GPSP ( {I}_{G} ) = \frac{AGP ( {I}_{G} )}{GP ( {I}_{G} )} \cdot \frac{GE ( {I}_{{θ}_{main}} )}{GE ( {I}_{{θ}_{aux}} )} \qquad ( 25 )$$

Since the definition of GPSP relies on I_{θmain} and I_{θaux}, the importance of their optimal selection is herein underscored. For maximum accuracy, I_{θmain} and I_{θaux} need to be chosen such that the resulting GPSP is well-defined.

(7) Phase Profile Shifting Profile: The normalized shape of the phase profile also changes across different gain indices. The phase profile shifting profile quantifies the phase shift offset by relating the two captured phase profiles:

$$PPSP ( {I}_{θ} ) = APP ( {I}_{θ} ) - PP ( {I}_{θ} ) - G 2 Δ θ ( {I}_{{G}_{aux}} ) \qquad ( 26 )$$

The PPSP varies with different selections of I_{Gmain} and I_{Gaux}. Since the I_{Gmain} is fixed at I_{Gmax}, the selection of I_{Gaux} becomes critical to ensure a well-defined PPSP.

Section I-C. Constellation Model Construction: After acquiring the mapping functions as defined in Section I-B, the gain and phase response models in (8) and (9) can be reconstructed as:

$${f}_{G} ( {I}_{G} , {I}_{θ} ) = GP ( {I}_{G} ) \cdot \frac{GE ( {I}_{θ} )}{GE ( {I}_{{θ}_{main}} )} \cdot {k}_{G} ( {I}_{G} , {I}_{θ} ) \qquad ( 27 )$$

$${f}_{G} ( {I}_{G} , {I}_{θ} ) = PP ( {I}_{θ} ) + G 2 Δ θ ( {I}_{G} ) + {k}_{θ} ( {I}_{G} , {I}_{θ} ) \qquad ( 28 )$$

where k_{G} and k_{θ} represent the gain and phase correction factors, respectively.

For the expression of the gain correction factor k_{G}(I_{G},I_{θ}), we begin by calculating its sampled values according to (4) and (5), respectively:

$$\begin{matrix}{k}_{G} ( {I}_{G} , {I}_{{θ}_{aux}} ) = \frac{\vert f ( {I}_{G} , {I}_{{θ}_{aux}} ) \vert}{\vert f ( {I}_{G} , {I}_{{θ}_{main}} ) \vert} \cdot \frac{\vert f ( {I}_{{G}_{main}} , {I}_{{θ}_{main}} ) \vert}{\vert f ( {I}_{{G}_{main}} , {I}_{{θ}_{aux}} ) \vert} \\ = \frac{AGP ( {I}_{G} )}{GP ( {I}_{G} )} \cdot \frac{GE ( {I}_{{θ}_{main}} )}{GE ( {I}_{{θ}_{aux}} )} \\ = GPSP ( {I}_{G} )\end{matrix} \qquad ( 29 )$$

$$\begin{matrix}{k}_{G} ( {I}_{{G}_{aux}} , {I}_{θ} ) = \frac{\vert f ( {I}_{{G}_{aux}} , {I}_{θ} ) \vert}{\vert f ( {I}_{{G}_{main}} , {I}_{θ} ) \vert} \cdot \frac{\vert f ( {I}_{{G}_{main}} , {I}_{{θ}_{main}} ) \vert}{\vert f ( {I}_{{G}_{aux}} , {I}_{{θ}_{main}} ) \vert} \\ = \frac{AGE ( {I}_{θ} )}{GE ( {I}_{θ} )} \cdot \frac{GE ( {I}_{{θ}_{main}} )}{AGE ( {I}_{{θ}_{main}} )} \\ = \frac{GESP ( {I}_{θ} )}{GESP ( {I}_{{θ}_{main}} )}\end{matrix} \qquad ( 30 )$$

Given that the gain control relationship is expected to remain consistent across different phase indices, the sampled k_{G}(I_{G},I_{θaux}) should serve as a representative shape for k_{G}(I_{G},I_{θ}) given any I_{θ}. This representative shape is assigned a dedicated mapping function, GPSP, and is used as the base for adjustments along the/e-axis. The adjustment must also satisfy the boundary conditions at I_{θmain} and I_{Gmain}, as outlined in (6) and (7):

$${k}_{G} ( {I}_{G} , {I}_{{θ}_{main}} ) = 1 , {k}_{G} ( {I}_{{G}_{main}} , {I}_{θ} ) = 1 \qquad ( 31 )$$

To satisfy these conditions, the expression for k_{G}(I_{G},I_{θ}) is derived by scaling the sampled correction factor k_{G}(I_{G},I_{θaux}) around the baseline of k_{G}(I_{G},I_{θmain})=1, ensuring that it crosses the observed value suggested by k_{G}(I_{Gaux},I_{θ}):

$$\begin{matrix}{k}_{G} ( {I}_{G} , {I}_{θ} ) = \frac{{k}_{G} ( {I}_{{G}_{aux}} , {I}_{θ} ) - 1}{{k}_{G} ( {I}_{{G}_{aux}} , {I}_{{θ}_{aux}} ) - 1} ( {k}_{G} ( {I}_{G} , {I}_{{θ}_{aux}} ) - 1 ) + 1 \\ = \frac{\frac{GESP ( {I}_{θ} )}{GESP ( {I}_{{θ}_{main}} )} - 1}{GPSP ( {I}_{{G}_{aux}} ) - 1} ( GPSP ( {I}_{G} ) - 1 ) + 1\end{matrix} \qquad ( 32 )$$

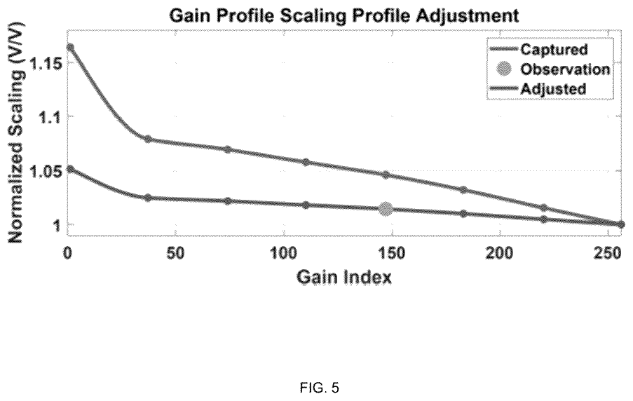

This operation can be viewed as adjusting the GPSP so that it appears as if it is captured with I_{θaux} equal to the/e values of interest. An example of this adjustment is shown in FIG. 5, where the adjusted GPSP retains its original shape while intersecting the observed value at I_{Gaux}.

Similarly, for the expression of the phase correction factor k_{θ}(I_{G},I_{θ}), we begin by calculating its sampled values according to (5) and (4), respectively:

$$\begin{matrix}{k}_{θ} ( {I}_{{G}_{aux}} , {I}_{θ} ) = ∠ f ( {I}_{{G}_{aux}} , {I}_{θ} ) + ∠ f ( {I}_{{G}_{main}} , {I}_{{θ}_{main}} ) - \\ ∠ f ( {I}_{{G}_{main}} , {I}_{θ} ) - ∠ f ( {I}_{{G}_{aux}} , {I}_{{θ}_{main}} ) \\ = APP ( {I}_{θ} ) - PP ( {I}_{θ} ) - G 2 Δ θ ( {I}_{{G}_{aux}} ) \\ = PPSP ( {I}_{θ} )\end{matrix} \qquad ( 33 )$$

$$\begin{matrix}{k}_{G} ( {I}_{{G}_{aux}} , {I}_{θ} ) = \frac{\vert f ( {I}_{{G}_{aux}} , {I}_{θ} ) \vert}{\vert f ( {I}_{{G}_{main}} , {I}_{θ} ) \vert} \cdot \frac{\vert f ( {I}_{{G}_{main}} , {I}_{{θ}_{main}} ) \vert}{\vert f ( {I}_{{G}_{aux}} , {I}_{{θ}_{main}} ) \vert} \\ = \frac{AGE ( {I}_{θ} )}{GE ( {I}_{θ} )} \cdot \frac{GE ( {I}_{{θ}_{main}} )}{AGE ( {I}_{{θ}_{main}} )} \\ = \frac{GESP ( {I}_{θ} )}{GESP ( {I}_{{θ}_{main}} )}\end{matrix} \qquad ( 30 )$$

Since the phase control relationship is expected to be consistent across different gain indices, the sampled k_{θ}(I_{Gaux},I_{θ}) serves as a representative shape for k_{θ}(I_{G},I_{θ}) given any I_{G}. This representative shape is assigned a dedicated mapping function, PPSP, and is used as the base for adjustments along the I_{G}-axis. The adjustments must satisfy the following boundary conditions at I_{θmain} and I_{Gmain}:

$$\begin{matrix}{k}_{θ} ( {I}_{G} , {I}_{θ} ) = \frac{{k}_{θ} ( {I}_{G} , {I}_{{θ}_{aux}} )}{{k}_{θ} ( {I}_{{G}_{aux}} , {I}_{{θ}_{aux}} )} \cdot {k}_{G} ( {I}_{{G}_{aux}} , {I}_{θ} ) \\ = \frac{AG 2 Δ θ ( {I}_{G} ) - G 2 Δ θ ( {I}_{G} )}{PPSP ( {I}_{{θ}_{aux}} )} \cdot PPSP ( {I}_{θ} )\end{matrix} \qquad ( 36 )$$

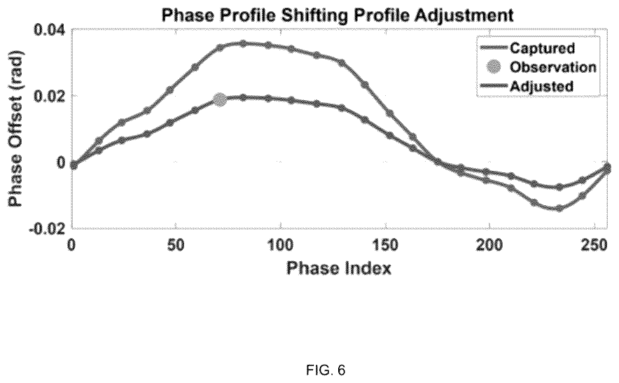

This operation can be viewed as adjusting the PPSP so that it appears as if it is captured with I_{Gaux} equal to the/G values of interest. An example of this adjustment is shown in FIG. 6, where the adjusted PPSP retains its original shape while intersecting the observed value at I_{θaux}.

Section I-D. Characterization Subset Optimization: Considering the modeling process and the method of deriving the correction factor described in Section I-C, the assumption that GPSP and PPSP exhibit representative shapes is crucial for ensuring the accuracy of the correction factors. The optimization of the characterization subset focuses on selecting optimal values for I_{θmain}, I_{θaux}, and I_{Gaux} that produce well-defined shapes for GPSP and PPSP, thereby maximizing the likelihood that they are representative.

Deriving from the relationships in (29) and (30), the value of the captured GPSP at the I_{Gaux} for any arbitrary I_{θmain} and I_{θaux} is:

$$GPSP ( {I}_{{G}_{aux}} ) = \frac{GESP ( {I}_{{θ}_{aux}} )}{GESP ( {I}_{{θ}_{main}} )} \qquad ( 37 )$$

To achieve the most defined GPSP, the value in (37) needs to be maximized. Additionally, since I_{θaux} is where the observation lays in the PPSP, it is essential to have a significant value for PPSP at I_{θaux}. Realizing the above considerations, I_{θmain} and I_{θaux} are chosen as:

$${I}_{{θ}_{main}} = arg min ( GESP ( {I}_{θ} ) ) \qquad ( 38 )$$

$${I}_{{θ}_{aux}} = arg min ( \vert PPSP ( {I}_{θ} ) \vert \cdot GESP ( {I}_{θ} ) ) ) \qquad ( 39 )$$

Deriving from the relationships in (33) and (34), the value of the captured PPSP at the I_{θaux} for any arbitrary I_{Gaux} is:

$$PPSP ( {I}_{{θ}_{aux}} ) = AG 2 Δ θ ( {I}_{{G}_{aux}} ) - G 2 Δ θ ( {I}_{{G}_{aux}} ) \qquad ( 40 )$$

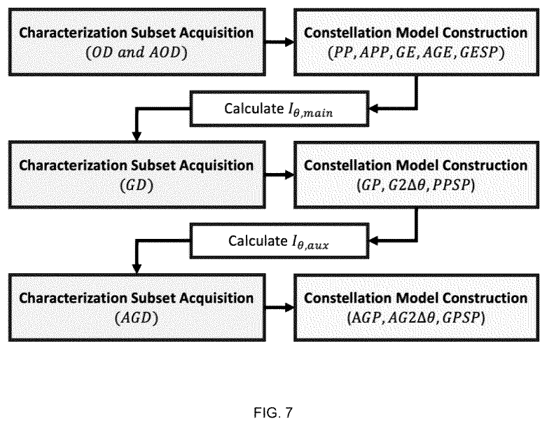

Since both G2Δθ and AG2Δθ are non-periodic series, there is no choice of I_{Gaux} other than the ends that maximizes PPSP. To avoid the extremes, I_{Gaux} is chosen to be the middle value in the range of the gain sampling indices subset. An optimized flow for the modeling process, comprising the optimal selection of the fixed indices, is shown in FIG. 7.

Section II. Array Calibration Routine: To generate a look-up table (LUT) that corresponds to the desired constellation, control codes for each target point must be determined. Using the disclosed constellation model, the method of the invention is used to determine the gain index I_{G} and phase index I_{θ} corresponding to a constellation point with the desired gain and phase.

To address the coupling between the gain and phase response models in (27) and (28), the method of the invention iteratively refines the solution until the indices converge for the target gain Gₜ and phase θₜ. Let I_{G}′ and I_{θ}′ denote the current estimates of the gain and phase indices, respectively. The method begins with an “initial value” for one of the indices.

The gain and phase response models are used to determine the appropriate gain and phase control codes for a desired gain (Gₜ) and phase (θₜ). However, due to the bivariate nature of these models, it is not possible to directly solve for the gain and phase control indices. Considering only the gain response function (ƒ_{G}), yields multiple solutions that satisfy the target gain (Gₜ). To resolve this, fixing the phase control index reduces the problem to a univariate function, which has a unique solution that can be determined using numerical methods—assuming the function is monotonic, a valid assumption for most BFIC implementations.

If the gain index is initially set to the main gain index, the initial estimates are:

$${I}_{G}^{′} = {I}_{{G}_{main}} \qquad ( 41 )$$

$${I}_{θ}^{′} = {f}_{θ}^{- 1} \text{?} ( {θ}_{t} ) = {PP}^{- 1} ( {θ}_{t} ) \qquad ( 42 )$$

$$\text{?} \text{indicates text missing or illegible when filed}$$

The operation in (42) involves reversing the input and output of a numerically computed series, followed by interpolation. The algorithm then iteratively refines these estimates using the following steps:

$${I}_{G}^{′} = {f}_{G}^{- 1} \text{?} ( {G}_{t} ) \qquad ( 43 )$$

$${I}_{θ}^{′} = {f}_{θ}^{- 1} {\vert}_{{I}_{G} = {I}_{G}^{′}} ( {θ}_{t} ) \qquad ( 44 )$$

$$\text{?} \text{indicates text missing or illegible when filed}$$

The initial value will be validated through the relationships (43) and (44). By repeatedly applying these operations, the correct initial value consistently returns as the solution in subsequent iterations. If the initial value for the gain control index is accurate, the phase control index computed from the phase response model—when used as the fixed variable in the gain response model—will reproduce the original gain control index.

This mutual consistency ensures that the solved gain and phase control indices simultaneously achieve the desired gain and phase according to both response models. If the initial value is incorrect, the iterative process naturally moves closer to the true solution, ensuring convergence.

While there is no single method for selecting the initial value, the iterative process converges regardless of the starting point. In the present invention the initial value is assigned to the gain control index, and it is set to the main gain index (I_{θ}_{ₘₐᵢₙ}) so that the corresponding phase response model is reduced to only the phase profile (PP(I_{θ})) as shown in (41) and (42):

The described implementation reduces computation time for the initial iteration. Alternatively, the iterative process could also begin with an initial value for the phase control index, and it would still converge to the same solution. This flexibility in choosing the starting point further enhances the robustness of the disclosed method.

Lastly, iterative process is employed to compute the gain control index solution using the gain response model and to compute the phase control index solution using the phase response model. This approach ensures stability because fixing the gain control index in the gain response model constrains the function range versus the phase control index, potentially preventing it from achieving the desired gain. Similarly, fixing the phase control index in the phase response model constrains the function range versus the gain control index, potentially preventing it from achieving the desired phase.

The iteration continues until I′_{G} and I′_{θ} converge. At this point, the final values of I_{G} and I_{θ} are saved to the LUT.

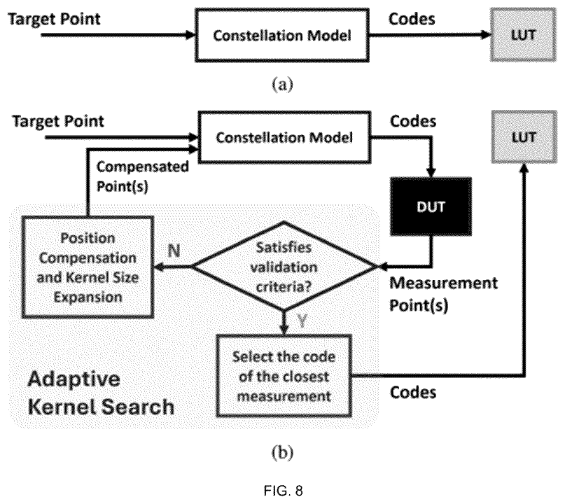

Open-loop or Closed-loop routines are used to complete the calibration process. The Open-loop calibration routine is illustrated in FIG. 8(a). It relies on the constellation model to determine the LUT corresponding to the desired constellation. Thus, the number of measurements is a minimum constant, set by the required measurements for the characterization subset acquisition, irrespective of the number of targeted points in the desired constellation.

The Closed-loop calibration routine, illustrated in FIG. 8(b), operates on a point-by-point basis. It acts as a failsafe for accuracy by actively verifying every disclosed solution by the constellation model. If the measured point deviates from the desired point, new gain and phase indices must be proposed with corresponding measurement(s) closer to the targeting point. The process for validation and proposition of new point(s) is called the adaptive kernel search algorithm which is described in detail in Section II-A. A gain-optimized tapering approach for achieving the maximum array power is described in Section II-B.

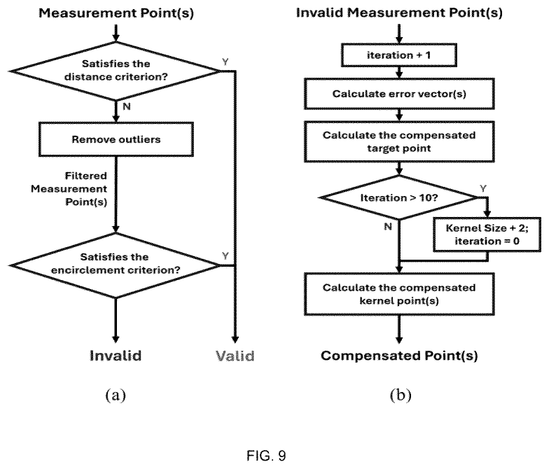

Section II-A. Adaptive Kernel Search Algorithm: As illustrated in FIG. 8(b), the closed-loop calibration process begins with the algorithm utilizing the constellation model to identify the gain and phase indices corresponding to the target constellation point. The selected indices are then applied, and the resulting measured point(s) are assessed against predefined “Validation Criteria.” If any disqualifications occur, the algorithm iterates by selecting alternative point sets to achieve a verified solution for the target point through a process termed “Position Compensation.” Should the measurements fail to converge to the target point, the search area, referred to as the “Kernel,” is expanded in subsequent iterations. The following subsections provide detailed explanations of the kernel, validation criteria, and position compensation. Flowcharts depicting the adaptive kernel search procedure are presented in FIG. 9.
1) Kernel Definition: A kernel K of size N is a search area consisting of N×N points that can be expressed as:

$$K = [ \begin{matrix}K ( 1 , 1 ) & … & K ( 1 , N ) \\ ⋮ & ⋱ & ⋮ \\ K ( N , 1 ) & … & K ( N , N )\end{matrix} ] , N = 1 , 3 , 5 , \qquad ( 45 )$$

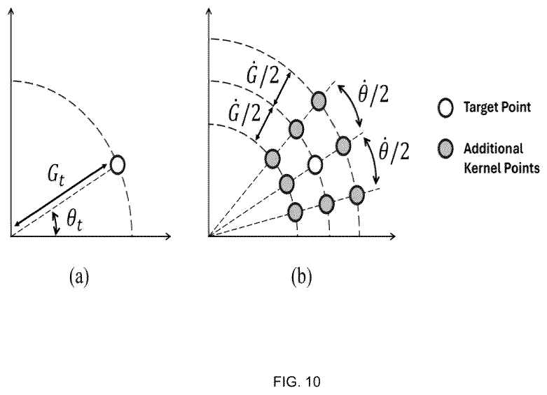

FIG. 10 provides kernel demonstration for two cases. In the calibration routine, kernel size is initially set to 1, which means the initial search area is just the target point with the absolute value of Gₜ and phase of er. When the kernel size expands, the target point will be surrounded by additional points all spaced away from each other by half a step of VGPS resolution. Let P_{G,θ} denotes the point with an absolute value of G and a phase of θ:

$${P}_{G , θ} = G \cdot {e}^{j θ} \qquad ( 46 )$$

Then each element in the kernel is defined as:

$$K ( i , j ) = \text{?} \qquad ( 47 )$$

$$\text{?} \text{indicates text missing or illegible when filed}$$

in which, ^{G} and θ represent the VGPS gain and phase resolution, correspondingly. The order of measurement for elements in the kernel does not matter. For example, a kernel of size 3 would be:

$${K}_{3} = [ \text{?} ] \qquad ( 48 )$$

$$\text{?} \text{indicates text missing or illegible when filed}$$

2) Validation Criteria: The validation criteria aim to determine if the current set of measurements contains a solution for the current target point. Once validated, the gain and phase indices corresponding to the closest measurement to the target point will be saved to the LUT The “Distance Criterion” and the “Encirclement Criterion” are defined as follows:

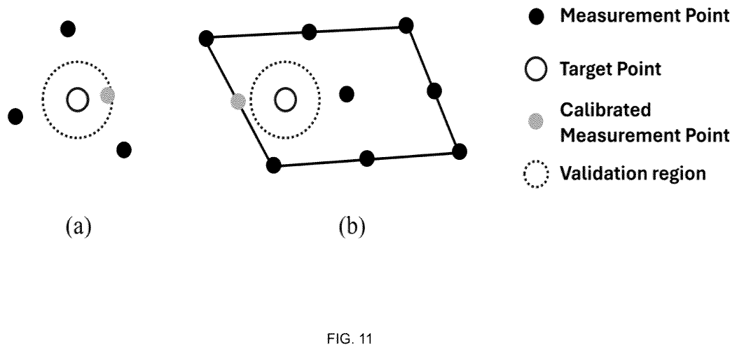

The distance criterion checks if there is any point in the current set of measurements that falls in the vicinity of the target point. As depicted in FIG. 11(a), a measurement is marked as valid if it falls within a circular validation region. The radius of the validation region, Rᵥₐₗ, is calculated individually for each target point as:

$${R}_{val} = min ( \vert \text{?} \vert ) \text{?} \frac{1}{T} , for T \geq 2 \qquad ( 49 )$$

$$\text{?} \text{indicates text missing or illegible when filed}$$

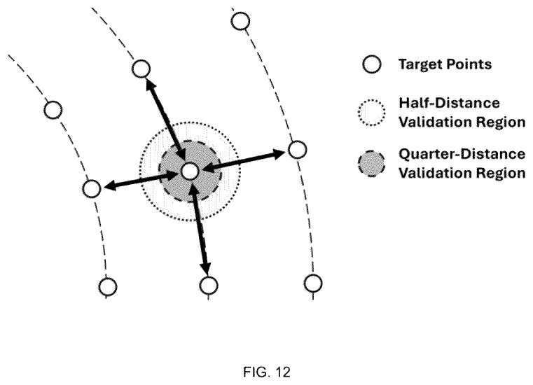

In (49), a higher validation tolerance coefficient results in stricter criteria for gain and phase error. Conversely, the most relaxed distance criterion is achieved with T=2, demonstrated by the half-distance validation region in FIG. 12. In this case, the validation regions of different target points may at most touch each other but do not overlap.

If a kernel larger than size 1 fails the distance criterion, the encirclement criterion is applied as shown in FIG. 9. A graphical example is in FIG. 11(b). The encirclement criterion checks if the kernel's measurements surround the target point. If so, with kernel points spaced at half the VGPS resolution away from the target point, no other control indices are likely to improve accuracy. Therefore, the gain and phase indices of the closest measured point are taken as the optimal solution, after filtering outliers to avoid boundary distortion.

3) Position Compensation: The position compensation process aims to identify the next set of constellation points with measurements that lay closer to the target point. By calculating error vector(s) from the ideal kernel point(s) to the measured one(s) in (50), an average error vector can be computed to determine the compensated target point (51). Let M_{K} denote the matrix of measured points corresponding to the kernel K, and e represent the matrix of error vectors for each point in the kernel. The entries of these matrices are given by M_{K}(ij) and e(ij), respectively.

$$e ( i , j ) = {M}_{K} ( i , j ) - K ( i , j ) \qquad ( 50 )$$

$$\text{?} = \text{?} - mean ( e ) = \text{?} - \text{?} = \text{?} \qquad ( 51 )$$

$$\text{?} \text{indicates text missing or illegible when filed}$$

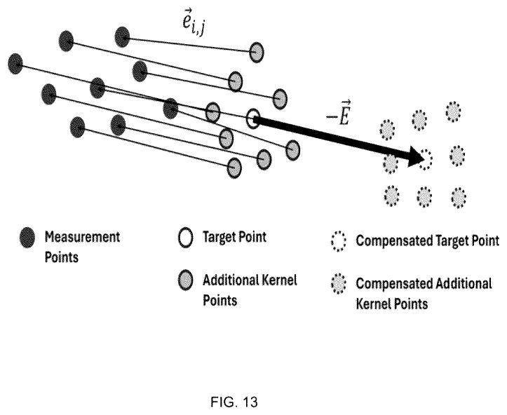

Next, a new kernel is built around the compensated target point and measured in the next iteration. This process is depicted in FIG. 13. The kernel size expands if the compensated kernel remains invalid after several iterations. Every measured state is stored in the calibration process to avoid repeated measurements for the same gain and phase indices.

Section II-B. Array Power Maximization with Taper Awareness: To accommodate gain tapering in typical array calibration processes [28], [29], power discrepancies between array elements are handled by limiting each BFICs maximum gain to match the one with the lowest measured gain. Then, BFICs are calibrated for multiple gain states following a specified gain tuning resolution. This approach is termed “Forced Tapering” in this work, as the taper is applied on top of limited and discrete calibrated gain states. Using this approach, array gain is typically lowered, and the side-lobe level (SLL) deteriorates due to quantization error.

Leveraging the disclosed constellation model, the present invention uses a “Taper Aware” approach for setting the targeting gain of each element in phased array antennas. By adapting the tapering profile to the maximum power levels of the elements, the array no longer targets the worst-case element gain thus achieving higher power. By directly targeting the tapered gains for each element, the need for gain tuning resolution is removed and the quantization error is maximally circumvented.

For an N×N array, let Gmax represent the matrix of maximum gain for each element, allowing for gain-invariant phase tuning. The entry for the ith element is calculated as:

$$\text{?} = 20 log ( min ( {GE}_{i} ) ) \qquad ( 52 )$$

$$\text{?} \text{indicates text missing or illegible when filed}$$

where GEᵢ is i^{th} element gain envelope. If C denotes the normalized gain taper coefficient matrix (in dB), the matrix of target gain for each element, Gₜ, can be calculated as follows:

$$\text{?} = C - max ( C - {G}_{max} ) \qquad ( 53 )$$

$$\text{?} \text{indicates text missing or illegible when filed}$$

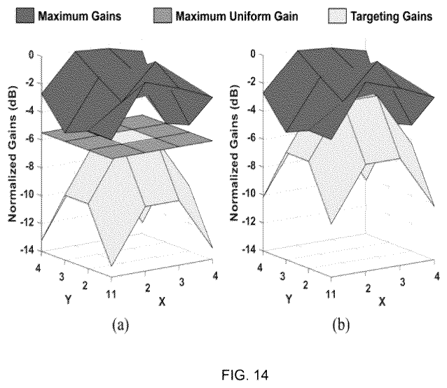

Targeting gains for a 4×4 phased array antenna using Taylor window gain tapering profile is demonstrated in FIG. 14. As observed, the disclosed taper-aware approach realizes a higher final gain compared to forced tapering.

Section III. Evaluation Results: To evaluate the performance of the modeling method, calibration routines are applied at both IC and array levels. Measurements are conducted using a four-port vector network analyzer (N5247B) at 38.5 GHz, the center frequency for the chosen commercial BFICs, and 4×4 phased array antennas incorporating them in their design. This section details the measurement setups and provides summary tables comparing various calibration methods. Additionally, the sections on BFIC and array calibration include the calibrated constellations and radiation patterns, respectively.

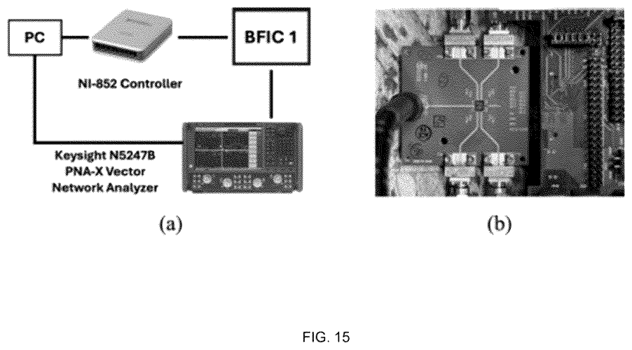

Section III-A. BFIC Calibration: The BFIC #1 is a quad-channel analog BFIC, operating in the frequency range of 37-40 GHz. This BFIC is selected for its high degree of freedom in targeting constellation points, facilitated by its 8-bit gain and 8-bit phase control. FIG. 15 shows the setup diagram for transmission coefficient measurement. To fairly challenge the viability of the disclosed calibration routines, gain and outline data sampling sizes are selected as 8 and 23. Also, by setting the validation tolerance coefficient to a relatively high number, T=10, the robustness of the closed-loop routine is validated.

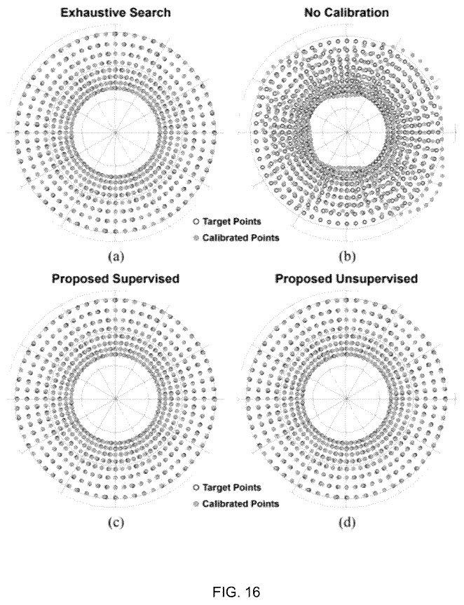

In FIG. 16, a series of measured constellations are shown for the two disclosed routines besides no-calibration and exhaustive search methods that serve as a benchmark.

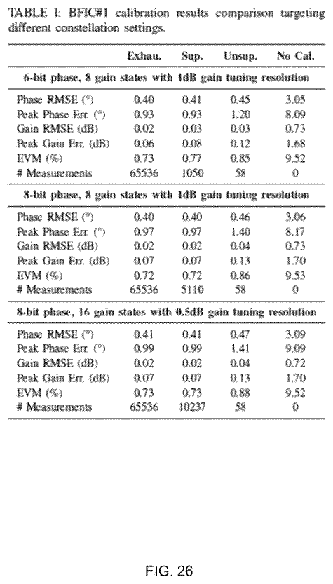

FIG. 26 (Table 1) presents a comparative analysis of calibration performance across various methods and target settings for phase and gain states. The open and closed loop calibration routines demonstrate phase and gain error metrics closely aligned with the exhaustive search method, with significantly fewer measurements required. Generally, the open loop calibration routine requires 58 measurements, approximately 0.1% of the measurements required for the exhaustive method, with a marginal increase of 0.15% in the error vector magnitude (EVM). This reduction speeds up the calibration process by over 1100 times. On the other hand, the closed loop calibration routine provides a reliable compromise between accuracy and measurement reduction. Optimally, the closed loop calibration routine needs 1.6% to 15.6% of the measurements required in the exhaustive approach, while maintaining EVM and peak errors close to the best achievable results from the exhaustive search method.

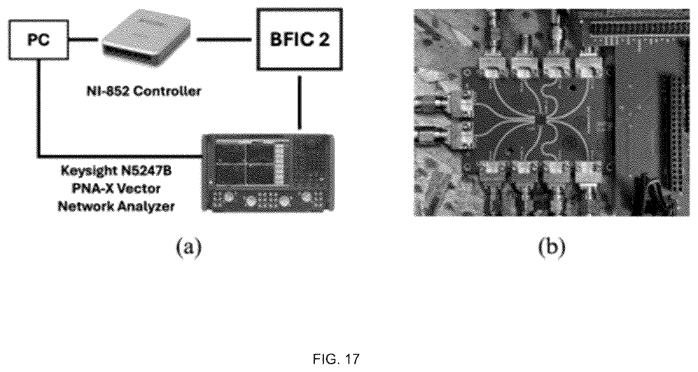

The BFIC #2 is a quad-channel dual-polarized (2×4) BFIC designed to operate within the 37-40 GHz frequency range. The BFIC is equipped with 4-bit gain and 6-bit phase control and is selected for its known phase/gain calibration-free feature. FIG. 17 shows the setup diagram used for measuring the transmission coefficient. Due to the lower bit resolution of the BFIC, the gain and outline data sampling sizes are adjusted to 4 and 10, respectively, to appropriately challenge the viability of the calibration routines. Additionally, the validation tolerance coefficient is set to T=2 to ensure a fair evaluation of performance.

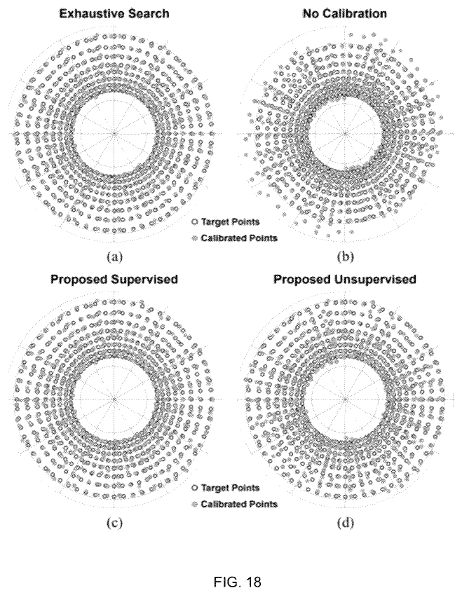

FIG. 18 illustrates the measured constellations of the BFIC #2 when targeting 64 phase and 8 gain states, with a gain tuning resolution of 1 dB. Due to the gaps and discontinuities present in the constellation, the accuracy of the constellation model deteriorates as evidenced by the closed loop constellation. Additionally, this unfavorable condition is exacerbated by the BFICs lower resolution, which limits the effectiveness of search-based methods, resulting in suboptimal outcomes for both exhaustive search and closed loop calibration.

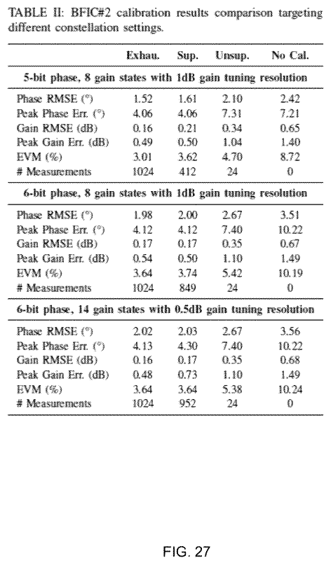

FIG. 27 (Table II) shows calibration results for different methods targeting various phase and gain states. The disclosed closed loop calibration routine demonstrates results that closely approximate those of the exhaustive search method while requiring fewer measurements. The measurement reduction is 60% for 32 phase and 8 gain states and decreased to almost 7% when the 6-bit phase and 14 gain states are targeted. In comparison, the open loop calibration routine provides a viable alternative when rapid calibration is prioritized with a 98% reduction in the number of measurements compared to the exhaustive method. Although higher errors are introduced using this routine, its EVM is half the no-calibration method.

Calibration results for BFIC #1 and BFIC #2 reveal the capability of the described routines as practical alternatives for the exhaustive search method to calibrate BFICs. The open loop calibration routine with a constant and significantly reduced number of measurements provides comprehensible accuracy enhancement even for BFIC #2 with a calibration-free feature. The closed loop calibration routine further enhances accuracy, particularly for BFICs with gaps and discontinuities in the constellations. Moreover, in the closed loop calibration routine, the measurement count scales proportionally with the targeting constellation size and desired accuracy, adding another layer of adaptability and efficiency.

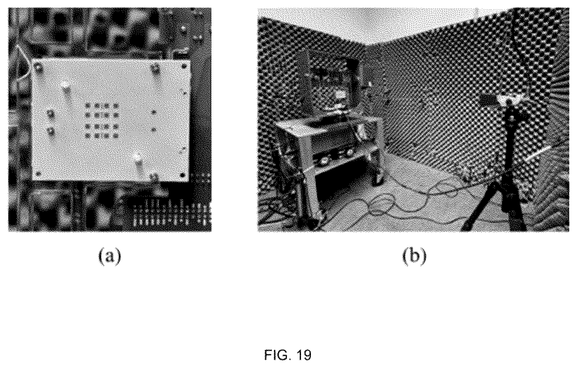

Section III-B. 4×4 Phased array antenna Calibration: Performance of the disclosed modeling method for phased array antenna calibration by evaluating radiation pattern measurements are conducted on two 4×4 antennas. The first array [33] incorporates BFIC #1, while the second array employs BFIC #2 for beamforming. As depicted in FIG. 19, the array under test (AUT) is mounted on a servo motor, with a horn antenna used to capture the far-field (FF) signal.

For the BFIC #1 phased array antenna, the calibration settings for the disclosed routines remain the same as before. The target side-lobe level (SLL) for Taylor window gain tapered measurements is −7.7 dB for both the disclosed taper-aware and the conventional forced tapering approach.

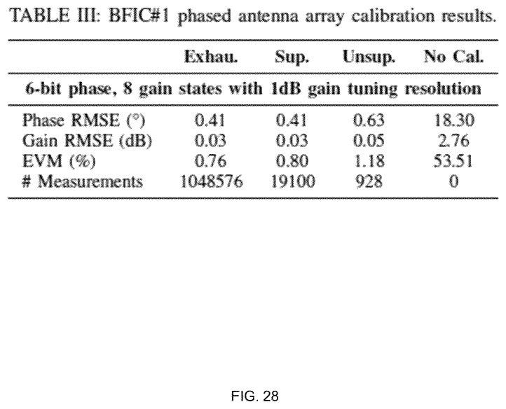

FIG. 28 (Table III) shows that the required measurements for the closed loop calibration routine is reduced by 98% compared to the exhaustive search method, from over a million measurements to below twenty thousand, maintaining the same phase and gain RMSE. The open loop calibration routine further reduces the number of measurements to only 0.09% for the exhaustive search but with a slight increase in errors.

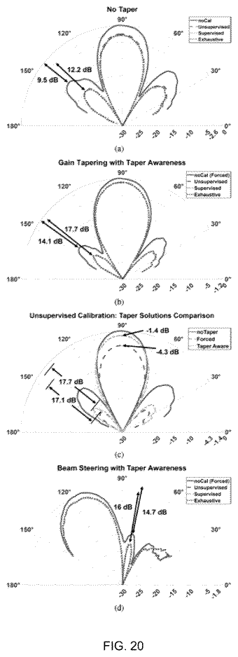

In FIG. 20, measured radiation patterns are illustrated. To fully exhibit beamforming performance for various gain and phase settings, sub-figures (a)-(c) are obtained with electrical beam steering, while FIG. 20(d) is captured rotating the AUT.

With and without gain taper, the described routines produce radiation patterns almost indistinguishable from those obtained via exhaustive search. As shown in FIG. 20(c), the taper-aware method yields a 2.9 dB higher gain while also achieving the target SLL of—17.7 dB, which is 0.6 dB better than the forced taper method that suffers from quantization errors. Slight imbalances that stem from overlooking dynamic current loading and antenna coupling effects in passive calibration, can also be adjusted using active calibration techniques previously introduced in the literature [19].

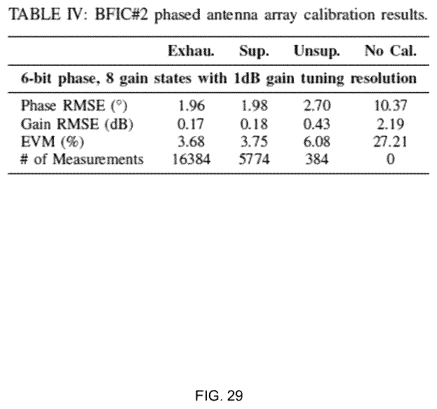

To calibrate the BFIC #2 phased array, the target SLL for gain-tapered measurements is increased to −15.8 dB, due to the limited achievable gain tuning range, and other settings are kept consistent with the corresponding IC measurements. As shown in FIG. 29 (Table IV), the closed loop calibration method achieves performance comparable to the exhaustive search method while reducing the measurements by 75%. The open loop calibration further reduces the measurement count by 98%, though it incurs some penalties in accuracy.

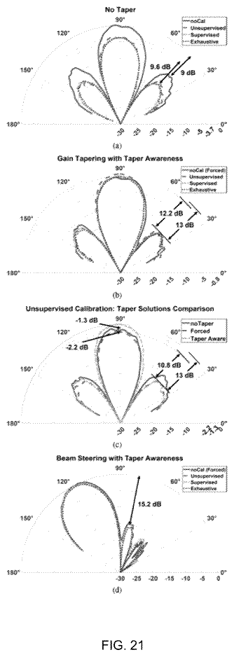

FIG. 21(a) highlights the importance of array calibration, even for BFICs with a calibration-free feature. However, a 3.7 dB gain loss is observed after calibration, attributed to the gain-limiting mechanism used to ensure gain uniformity across the elements in the array. In the case of BFIC #2 phased array, the significant power variation between elements necessitated a considerable power back-off for high-gain elements.

As shown in FIG. 21(c), this compromise is mitigated by a 1.3 dB gain improvement using the taper-aware approach, while also achieving 0.8 dB better SLL compared to forced tapering.

Calibration results for both phased array antennas demonstrate the effectiveness of the described calibration routines, producing radiation patterns nearly identical to those achieved with the exhaustive search method. Additionally, the disclosed taper-aware approach is validated by delivering higher gain and lower SLL compared to forced tapering. FIG. 21 further highlights the importance of maintaining consistent power across all elements and underscores the benefits of using BFICs with greater gain tuning range.

The disclosed system provides a novel constellation modeling method that significantly accelerates the calibration of BFICs and RF chains within phased array antennas. When applied to commercial BFICs and phased array antennas, the method reduced the number of required measurements by up to 1100 times compared to the exhaustive search method, while achieving nearly identical constellations and radiation patterns. The evaluation results demonstrate the effectiveness of the disclosed constellation model and the applicability of the calibration routines. The closed loop calibration routine showed robust performance and adaptability with the number of measurements increasing proportionally to the desirable accuracy and constellation size. Evaluation results also confirm the efficacy of the taper-aware approach for setting array element target gains, achieving higher gains and lower sidelobe levels compared to conventional methods. Therein the disclosed method and system offer a highly efficient solution for calibrating and programming large, high-resolution phased array antennas.

It will be appreciated that variations of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the description above and the following claims.

What is claimed is:

1. A system for calibrating and programming a phased array antenna, comprising:
a beamforming subsystem including one or more beamforming integrated circuits (BFICs) and a phased array antenna, the beamforming subsystem configured to generate an RF radiated signal;
at least one feedback receiver arranged to receive the RF radiated signal and to generate a corresponding feedback signal;
a characterization subsystem coupled to the at least one feedback receiver and including signal-processing circuitry configured to process the feedback signal and to generate measured constellation data;
a calibration module coupled to the characterization subsystem and including processing circuitry configured to receive the measured constellation data, to generate a constellation model based on the measured constellation data, and to output calibrated constellation control codes;
a look-up table (LUT) stored in a memory and configured to store the calibrated constellation control codes; and
processing unit coupled to the LUT and including control logic configured to apply the calibrated constellation control codes to the one or more BFICs;
wherein application of the calibrated constellation control codes causes the beamforming subsystem to generate the RF radiated signal with a desired constellation.

2. The system of claim 1, wherein the calibration module is configured to capture a characterization subset of the measured constellation data.

3. A system for calibrating and programming a phased array antenna, comprising:
a beamforming subsystem including one or more beamforming integrated circuits (BFICs) and a phased array antenna, the beamforming subsystem configured to generate an RF radiated signal;
a calibration module coupled to the characterization subsystem and including processing circuitry configured to receive measured constellation data, to generate a constellation model based on the measured constellation data, and to output calibrated constellation control codes;
a look-up table (LUT) stored in a memory and configured to store the calibrated constellation control codes; and
processing unit coupled to the LUT and including control logic configured to apply the calibrated constellation control codes to the one or more BFICs;
wherein application of the calibrated constellation control codes causes the beamforming subsystem to generate the RF radiated signal with a desired constellation.

4. The system of claim 2, wherein the calibration module is configured to capture a characterization subset of the measured constellation data.

5. A system for calibrating and programming a phased array antenna, comprising:
a beamforming subsystem including one or more beamforming integrated circuits (BFICs) and a phased array antenna, the beamforming subsystem configured to generate an RF radiated signal;
a look-up table (LUT) stored in a memory and configured to store calibrated constellation control codes; and
processing unit coupled to the LUT and including control logic configured to apply the calibrated constellation control codes to the one or more BFICs;
wherein application of the calibrated constellation control codes causes the beamforming subsystem to generate the RF radiated signal with a desired constellation.

6. A method for calibrating and programming a phased array antenna, comprising:
generating an RF radiated signal using a beamforming subsystem including one or more beamforming integrated circuits (BFICs) and a phased array antenna;
receiving the RF radiated signal with at least one feedback receiver and generating a corresponding feedback signal;
processing the feedback signal with a characterization subsystem to generate measured constellation data;
generating, using a calibration module, a constellation model from the measured constellation data and producing calibrated constellation control codes;
storing the calibrated constellation control codes in a look-up table (LUT) stored in a memory; and
applying, using a processing unit coupled to the LUT, the calibrated constellation control codes to the one or more BFICs;
wherein applying the calibrated constellation control codes causes the beamforming subsystem to generate the RF radiated signal with a desired constellation.

7. The method of claim 6, wherein generating the constellation model comprises capturing, by the calibration module, a characterization subset of the measured constellation data.

8. A method for calibrating and programming a phased array antenna, comprising:
generating an RF radiated signal using a beamforming subsystem including one or more beamforming integrated circuits (BFICs) and a phased array antenna;
receiving measured constellation data;
generating, using a calibration module, a constellation model from the measured constellation data and producing calibrated constellation control codes;
storing the calibrated constellation control codes in a look-up table (LUT) stored in a memory; and
applying, using a processing unit coupled to the LUT, the calibrated constellation control codes to the one or more BFICs;
wherein applying the calibrated constellation control codes causes the beamforming subsystem to generate the RF radiated signal with a desired constellation.

9. The method of claim 8, wherein generating the constellation model comprises capturing, by the calibration module, a characterization subset of the measured constellation data.

10. A method for calibrating and programming a phased array antenna, comprising:
generating an RF radiated signal using a beamforming subsystem including one or more beamforming integrated circuits (BFICs) and a phased array antenna;
receiving measured constellation data;
storing the calibrated constellation control codes in a look-up table (LUT) stored in a memory; and
applying, using a processing unit coupled to the LUT, the calibrated constellation control codes to the one or more BFICs;
wherein applying the calibrated constellation control codes causes the beamforming subsystem to generate the RF radiated signal with a desired constellation.
